(19) United States
(12) Patent Application Publication
(10) Pub. No.: US 2003/0209647 A1
(43) Pub. Date: Nov. 13, 2003

(54) Temperature compensating optical debris analysis fixture

(75) Inventors: David Miller, Stow, OH (US); Paul Schweigert, Akron, OH (US)

Correspondence Address: Ray L. Weber, Renner, Kenner, Greive, Bobak, Taylor & Weber, First National Tower, Fourth Floor, Akron, OH, 44308-1456, US

(73) Assignee: Lockheed Martin Corporation

(21) Appl. No.: 10/143,638

(22) Filed: May 9, 2002

(51) Int. Cl. F16M 11/00

(52) U.S. Cl. 248/694; 248/200

(57) ABSTRACT

An optical debris analysis fixture for obtaining a precise focus point for imaging debris passing through an optical flow cell, includes a support rod assembly having a mounting block at one end and a camera block at an opposite end. A flow cell block slidably carried by the support rod assembly and a fixed rod is secured at one end to the mounting block and at an opposite end to the flow cell block. The support assembly includes a pair of parallel, spaced apart rods of substantially equal length. The parallel rods are made of a different material than the center rod so that any change in temperature causes the optical flow cell block to move no more than 50 microns with respect to the camera block.

### TECHNICAL FIELD

The present invention relates generally to fluid inspection systems. More particularly, the invention relates to a fixture that facilitates precise positioning and alignment of its components to ensure accurate imaging of debris viewed through an optical flow cell carried by the fixture. Specifically, the invention relates to a fixture that compensates for wide temperature variations to maintain the proper alignment of the components.

### BACKGROUND ART

It is known to provide fluid sampling devices using optical near-field imaging as disclosed in U.S. Pat. No. 5,572,320, which is incorporated herein by reference. Such a device is employed to determine the quantity, size, characteristics, and types of particulate matter in fluids. Examples of fluids which are monitored in such a system are lubricating oils used in engines and rotating machinery; hydraulic fluid used in various machinery; and fluids used in industrial quality control, food processing, medical analysis, and environment control. In its most common use, such a device monitors engine oil for metal particulates or flakes, wherein a size, number, and shape of particulates correspond to an engine condition and can alert one to particular problems with the engine. Non-metallic debris in the fluid can also be detected, such as fibers, sand, dirt and rust particles. Predicting failure is critically important in aircraft engines to avoid accidents and loss of life.

The early stages of engine wear cause small particulate matter, of about 50 microns or less in size, to be generated. These particulates have characteristic shapes indicative of the type of wear produced by specific wear mechanisms. As the wear process progresses, the amount and size of particulates increase. Accordingly, imaging and identifying smaller particles allows early identification of faults, thus, allowing more time for corrective maintenance and preventing unexpected catastrophic failures.

The advantage of the aforementioned system over previous systems is readily apparent when one considers that the previous systems only measured the amount of light passing through the material-laden oil, but gave no consideration as to the particular shape of the material. As best seen in FIGS. 1A-G, the various types of images rendered by a known system can provide a clear indication of the types of problems that are likely to occur based upon the shape and structure of the debris monitored. For example, in FIG. 1A, sliding wear particles are shown and these particles are believed to be caused by metal-to-metal contact due to overloading, misalignment, low speed and/or low oil viscosity. The debris shown in FIG. 1B represents fatigue wear particles which are gear or bearing pieces generated due to surface stress factors such as excessive load, contamination, and the like. FIG. 1C shows cutting wear particles that are generated by surface gouging, two body cutting due to break-in, misalignment, and three body cutting due to particle abrasion. FIG. 1D shows oxide particles which are caused by contamination, and red oxide caused by water or insufficient lubrication of the subject machinery.

It will also be appreciated that certain elements may be in the oil that generate false readings. These elements are classified and can be disregarded by the imaging system. For example, as shown in FIG. 1E, fibers are shown which are normally occurring or may be caused by improper sample handling. Instrument problems due to incomplete removal of air bubbles are represented in FIG. 1F. Finally, FIG. 1G shows flow lines which are a result of instrument problems caused by insufficient mixing of a new sample.

In order for such an imaging system to work properly, the system must allow for proper focusing so that the field of view of the fluid to be imaged is within about plus or minus 25 microns. The debris-containing fluid is pumped through an optical flow cell which is typically held in a fixed position. A laser light illuminates one side of the flow cell and a camera is positioned on the other side. The flow cell is movably positioned to obtain a proper focus. Accordingly, U.S. Pat. No. 6,104,483, which is incorporated herein by reference, facilitates positioning of a flow cell by using a defined reference flange. Although this optical flow cell improves the system's performance, positioning of the other components in the imaging system has been found to be lacking in prior art equipment. In other words, if the other components of the system used to image the fluid passing through the optical flow cell are not properly positioned and aligned, the image obtained by the system may be distorted or, in the worst case, not detected at all.

Previous fixtures employed a camera mounted on a slide device that was incrementally moved until a desired focus was obtained. This position was held in place by tightening screws associated with the slide device. As will be appreciated, tightening the screws slightly adjusts the position of the camera, which may result in the camera being removed from the desired field of view. Previous imaging fixtures also required access to both the top and bottom of a plate which supported the slide and other system components. Accordingly, making fine adjustments to the positioning of the camera and the optical flow cell were found to be quite cumbersome and, as a result, performance of routine maintenance on the device was found to be quite difficult. The previous fixture was also problematic in that all of the important components were moveable upon the holding plate and, as such, obtaining a proper focus for the camera was quite difficult.

One attempt at overcoming the aforementioned problems is disclosed in U.S. patent application Ser. No. 09/923,973, entitled “Optical Debris Analysis Fixture,” assigned to the Assignee of the present invention. In that application a fixture is utilized which includes a plate having a plurality of aligned component pin openings and a plurality of mount holes. Components that are secured to the plate have corresponding registration pins that are receivable in the component pin openings. This ensures that the components are in a fixed position except for an illuminator assembly which is slidably moveable along the plate. A pair of nudgers are provided to properly position the illuminator assembly with respect to the other components. When a desired position is obtained by moving the nudgers in the appropriate direction, the illuminator assembly is secured to the plate. Although this construction is effective in a controlled environment it has been found that any significant change in temperature results in thermal expansion of the plate which moves the illuminator assembly out of the required field of view. Therefore, there is a need in the art for an optical debris analysis fixture which is not as sensitive to temperature changes as previous fixtures.

For example, the camera and lens components of the analysis fixture have a field of view of approximately 150 microns. A cross-section of the optical flow cell that is carried by the illuminator assembly is approximately 100 microns. Accordingly, the current fixture is able to withstand about a 25 micron displacement in either direction in order for the optical flow cell to remain in the desired field of view. However, it has been found that a temperature rise of 17° F. causes the illuminator assembly to be moved approximately 52 microns and as such at least a portion of the optical flow cell is removed from the desired field of view. It will be appreciated that this movement effectively reduces the ability of the camera to properly image the debris traveling through the optical flow cell. The aforementioned 52 micron displacement is a result of using an aluminum baseplate. It has been found that a stainless steel baseplate exposed to a similar temperature increase would only displace the field of view about 23 microns; however, such a construction would significantly increase the cost and weight of a device. In any event, a 23 micron displacement is still considered to be undesirable.

### SUMMARY OF THE INVENTION

It is thus an object of the present invention to provide a temperature compensating optical debris analysis fixture.

The foregoing and other objects of the present invention, which shall become apparent as the detailed description proceeds, are achieved by an optical debris analysis fixture for obtaining a precise focus point for imaging debris passing through an optical flow cell, comprising a support assembly having opposed first and second fixed end; a flow cell block slidably carried by the support rod assembly; and a fixed rod secured at one end of the second fixed end and at an opposite end to the flow cell block.

Other aspects of the present invention are attained by a fixture for imaging particles passing through an optical flow cell, comprising: a camera block; a mounting block; a pair of parallel, spaced apart rods of substantially equal length having first and second ends, wherein the first ends are secured to the camera block and the second ends are secured to the mounting block; an optical flow cell block for carrying the optical flow cell, the optical flow cell block slidably carried by the pair of rods between the camera block and the mounting block; and a fixed rod extending from the mounting block, the optical flow cell block secured to one end of the fixed rod so that the optical flow cell block moves no more than 50 microns from a set position from the camera block even with a predetermined change in the ambient temperature.

These and other objects of the present invention, as well as the advantages thereof over existing prior art forms, which will become apparent from the description to follow, are accomplished by the improvements hereinafter described and claimed.

### BRIEF DESCRIPTION OF THE DRAWINGS

For a complete understanding of the objects, techniques and structure of the invention, reference should be made to the following detailed description and accompanying drawings, wherein:

FIGS. 1A-G are examples of different types of particles viewed by an optical debris analysis fixture according to the present invention;

FIG. 2 is a top perspective view of a temperature compensating optical debris analysis fixture according to the present invention;

FIG. 3 is an elevational view of the fixture;

FIG. 4 is a bottom plan view of the fixture;

FIG. 5 is a perspective view of a camera mounting block;

FIG. 6 is an elevational view of a support block;

FIG. 7 is an elevational view of a flow cell block;

FIG. 8 is a cross-sectional view of the flow cell block taken along line 8-8 of FIG. 7;

FIG. 9 is a perspective view of a flow cell door;

FIG. 10 is an elevational view of a mounting block; and

FIG. 11 is a cross-sectional view of the mounting block taken along line 11-11 of FIG. 10.

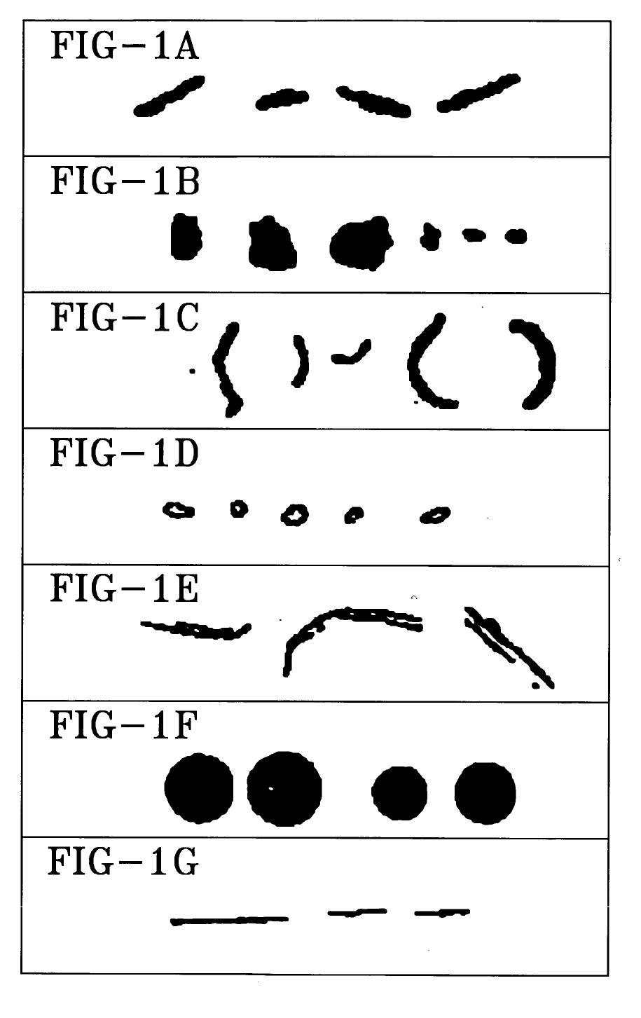

### BEST MODE FOR CARRYING OUT THE INVENTION

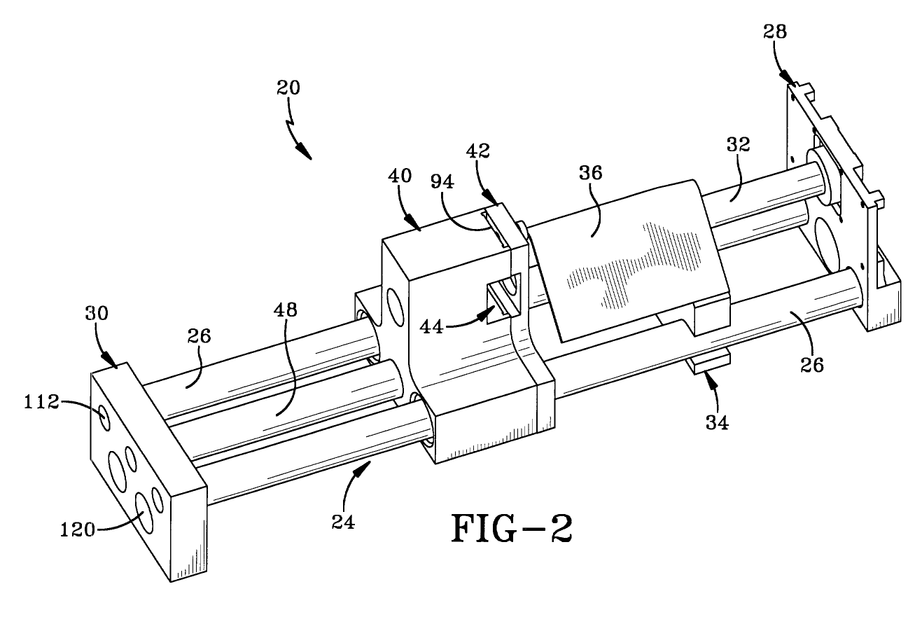

Referring now to the drawings and, more particularly to FIGS. 2-4, it can be seen that a temperature compensating optical debris analysis fixture, according to the present invention, is designated generally by the numeral 20. The fixture 20 is carried in a housing (not shown) and associated with other components, which will be discussed in detail below, to image particles contained in a fluid, such as engine oil, for the purpose of monitoring the operational properties of machinery associated with that fluid. Of course, the fixture 20 could be used to image particles or objects contained in other types of material. Generally, the fixture 20 includes a support assembly 24. The support assembly 24 includes a pair of supports rods 26 which are secured at one end to a camera block 28 and at an opposite end to a mounting block 30. The support rods 26 are positioned in parallel with one another and are of the same length. Although the rods shown have a circular cross-section, it will be appreciated that any other shape of rod could be employed. In a preferred construction, the rods 26 are made of 430 stainless steel. The camera block 28 is utilized for attaching a camera thereto and for fixably securing one end of the support assembly 24. The mounting block 30 provides a fixed end for the other end of the support assembly 24.

A lens 32 extends from the camera block 28 in the direction of the mounting block 30. A support block 34 is carried by the support rods 26 and functions to hold the other end of the lens 32 extending from the camera block 28. A lens cover 36 is carried by the support block 34.

A flow cell block, generally designated by the numeral 40, is slidably movable on the support rods 26. A flow cell door 42 is attachable to the flow cell block 40 and forms therewith a flow cell cavity 44 for receiving an optical flow cell (not shown) which is disclosed in U.S. Pat. No. 6,104,483 and incorporated herein by reference .

A center rod 48 is connected at one end to the mounting block 30 and extends in a direction toward the camera block 28. The opposite end of the center rod 48 is secured to the flow cell block 40 by virtue of a fastener cross hole 49. As such, the center rod 48 is fixed between the mounting block 30 and the flow cell block 40. In a preferred embodiment, the center rod 48 is made of 6061 aluminum which has a thermal expansion coefficient greater than the 430 stainless steel used in the construction of the support rods 26. Although the particular materials for the center rod and support rod are believed to be the preferred materials, any material could be selected for the center rod 48 and the support rods 26 as long as the ratio of the coefficients of thermal expansion is substantially equal to the inverse of the ratio of the respective lengths and provided that the flow cell 40 is positioned between the camera block 28 and the mounting block 30. For example, the coefficient of thermal expansion for the center rod is 0.0000131 inches per inch per degree F. and for the support rods is 0.0000058 inches per inch per degree F. With these known values, the ratio is 2.26:1. From this ratio and a known length value of either the support rods or the center rod, a length value for the other rod can be determined. In other words, if the predetermined length of the center rod plus the distance from the cross hole 49 to the flow cell channel 92 is 6.75 inches, this value is multiplied by the ratio of the coefficients of thermal expansion 2.26. This product equals a value of 15.25 inches which is the length of the support rods in order to ensure minimal movement of the optical flow cell with respect to the camera block.

With the optical flow cell mounted in the flow cell cavity 44, the flow cell block 40 is assembled to the support assembly 24 along with the other components. The flow cell block 40 is nudged into the proper position along the support rods 26 and the center rod 48. This may be accomplished by use of a temporary nudging fixture that is preferably mounted to the rod 26. Once the desired position is obtained, the flow cell block 40 is secured to the center rod 48 by a fastener 91 inserted into the cross hole 49. Accordingly, as the ambient temperature surrounding the fixture 20 increases, the support rods 26 expand lengthwise a predetermined amount. Likewise, the center rod 48 expands lengthwise a predetermined amount, but an amount so as to maintain the same distance between the flow cell block 40 and camera block 28 as before the change in temperature. Accordingly, the depth of field or field of view between the camera block 28 and the optical flow cell remains the same within a predetermined temperature range.

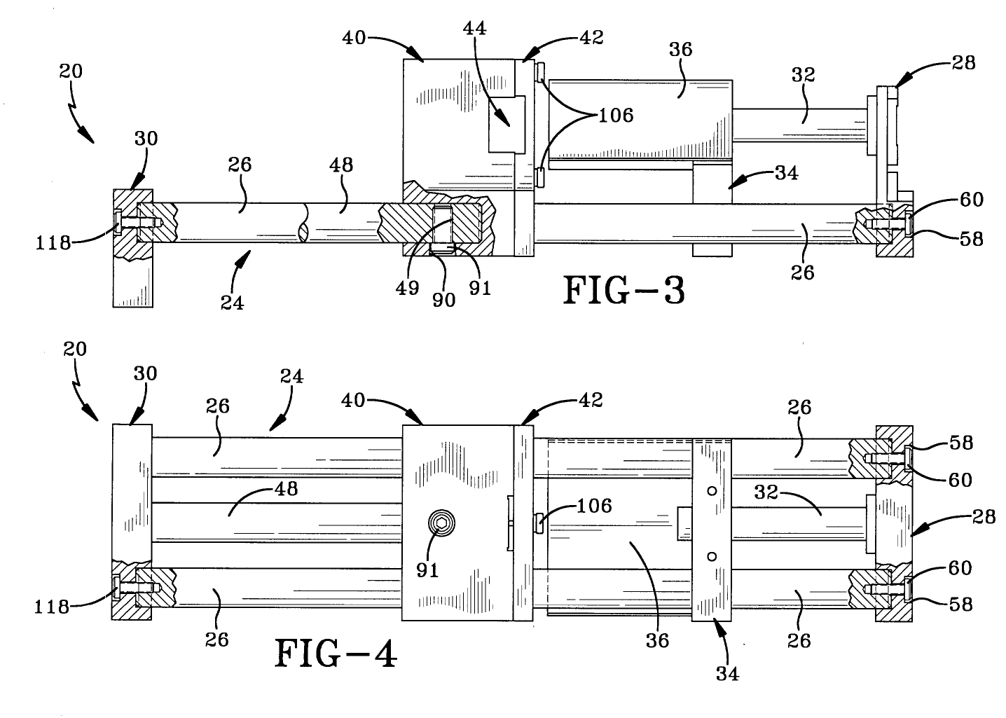

The camera block 28 as best seen in FIGS. 3-5 includes a camera side 50 upon which a camera or imaging device is mounted. Opposite the camera side 50 is a lens side 52. The camera block 28 provides a lens hole 53 for mountably receiving one end of the lens 32. The camera block 28 has a pair of holes 56 therethrough. On the lens side 52 the camera block 28 has a pair of support rod counterbores 54, each of which is concentric with a corresponding hole 56. On the camera side 50 the camera block 28 has a pair of fastener counterbores 58, each of which is concentric with a corresponding hole 56 and support rod counterbore 54. A fastener 60 extends into the through hole 56 and secures one end of the support rods 26, which are seated in the counterbore 45, to the camera block 28. Positioned between the through holes 54 and extending through the camera block 28 is a fixture hole 62 which may receive a rubber pad and which is securable to the case or frame that carries the fixture 20.

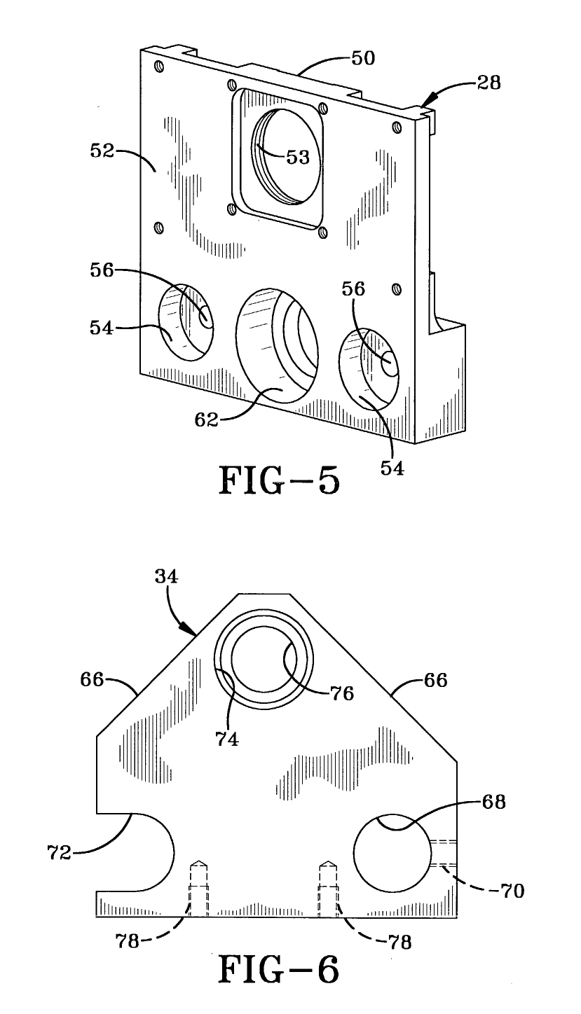

The support block 34, which is best seen in FIG. 6, provides angularly directed sides 66 which carry the lens cover 36. The support block 34 in one lower corner includes a rod hole 68 extending therethrough and a cross hole 70 which extends from one side of the support block 34 into the rod hole 68. In the other lower corner of the support block 34 is a rod notch 72. It will be appreciated that the support block 34 is slidably movable upon one of the support rods 26 via the rod hole 68 and the rod notch 72. When a position for the support block 34 is obtained a threaded fastener is inserted into the cross hole 70 and the support block 34 is secured to the selected support rod. The upper portion of the support block 34 has a lens hole 74 that extends therethrough. The lens hole 74 supports the other end of the lens 32. A lens O-ring 76 is received in the lens hole 74 and allows for slidable movement of the lens 32 with respect to the support block 34. Accordingly, as the support rods expand and contract, the end of the lens 32 is allowed to move with the camera block without distorting the field of view obtained by the lens and the camera. It will also be noted that the lens cover 36 extends in a direction toward the flow cell block 40 so as to prevent extraneous light or debris from interfering subject matter between the lens and the flow cell block. A bottom surface of the support block 34 also has a pair of attachment holes 78 for mounting of a laser used with the fixture 20.

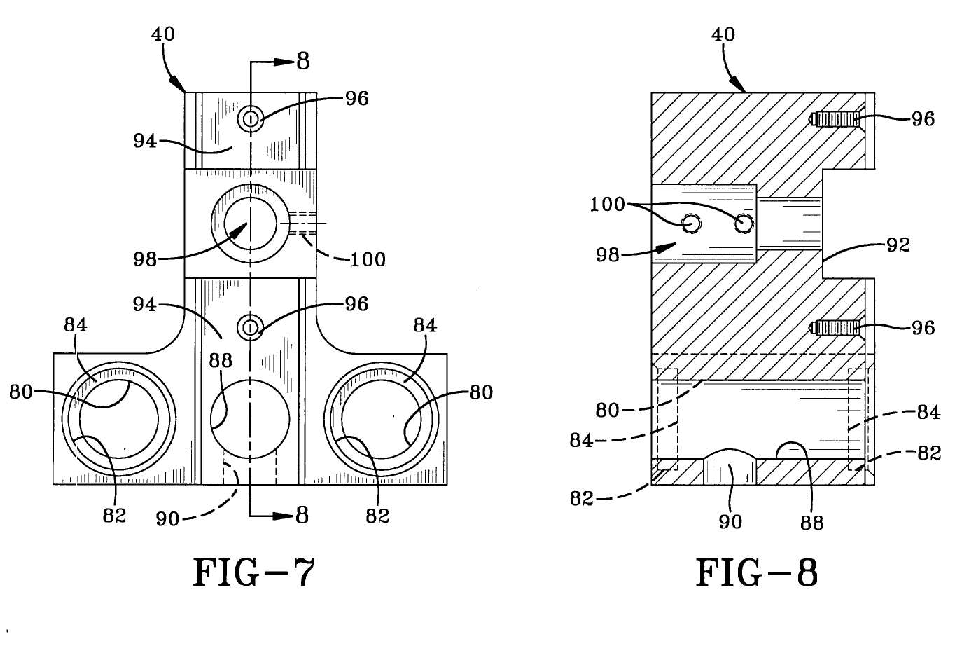

Referring now to FIGS. 2, 3, 7 and 8, it can be seen that the flow cell block is designated generally by the numeral 40. Extending through the base of the flow cell block 40 are a pair of support rod holes 80. At each end of the holes 80 is a ring counterbore 82 which receives an O-ring 84. The flow cell block 40 is slidably movable upon the support rods 24 and the O-rings function to preclude entry of contaminants or other materials that would otherwise interfere with the slidable movement of the flow cell block. Extending through the base of the flow cell block 40, and between the support rod holes 80 is a center rod hole 88 which receives the center rod 48. Perpendicularly extending through the bottom of the flow cell block 40 into the center rod hole 88 is a fastener hole 90 that is aligned with the cross hole 49. The fastener hole 90 and the cross hole 49 receives a threaded rod/flow cell fastener 91 which secures the flow cell block 40 to the center rod 48 as previously discussed. The flow cell block 40 includes a flow cell channel 92 that extends in a plane that is parallel with the plane formed by the two support rods 26. The flow cell block 40 also has a reference channel 94 that extends perpendicularly with respect to the flow cell channel 92. Extending into the flow cell block 40 in the area of the reference channel 94 are a pair of door holes 96. Extending through an upper portion of the flow cell block into the flow cell channel 92 is an illuminator cavity 98. The upper portion also provides an illuminator hole 100 that extends substantially perpendicular to the illuminator cavity 98. The illuminator cavity 98 is sized to receive an illuminator assembly (not shown) through which a laser light is directed into the flow cell cavity for illuminating the optical flow cell. The laser light allows for the camera (not shown) to image particles passing through the optical flow cell. The illuminator hole 100 receives a fastener which holds the illuminator assembly in the illuminator cavity 98.

Referring now to FIG. 9, it can be seen that a flow cell door is designated generally by the numeral 42. The flow cell door 42 has a pair of support rod holes 102 that are aligned with the support rod holes 80 of the flow cell block 40. Extending perpendicularly across the top portion of the flow cell door is a flow cell door channel 103. Also extending through the flow cell door 42 are a pair of flow cell holes 104 which are alignable with the door holes 96 of the flow cell block. The flow cell door 42 is slidably movable upon the support rods 26 and with the optical flow cell body received in the flow cell channel 92 and the door channel 103 and the reference flanges of the flow cell received in the reference channel 94, closure of the flow cell door 42 is accomplished by inserting fasteners 106 into the holes 104 and securing them into holes 96. Accordingly, when the flow cell door 42 is secured to the flow cell block 40 the flow cell cavity 44 is formed. The flow cell door 42 provides a flow cell window 108 which is aligned with the viewing area of the optical flow cell so as to allow imaging of particles passing through the flow cell. It will be appreciated that once the flow cell door 42 is secured to the flow cell block 4, both components move on the support rods 26 as the center rod 48 expands and contracts.

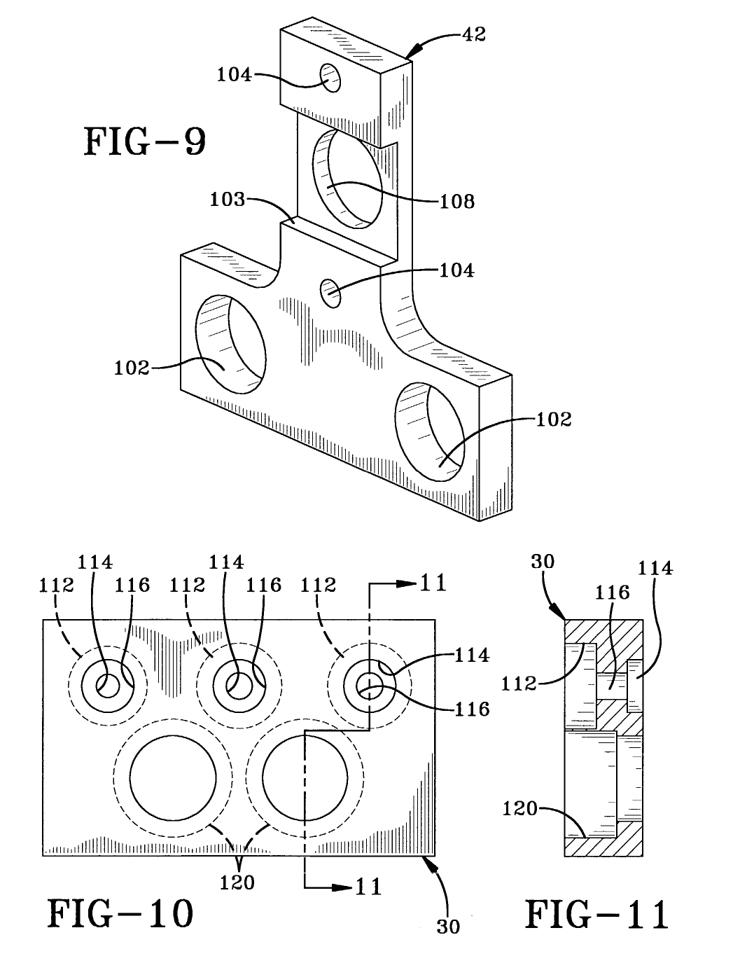

Referring now to FIGS. 10 and 11, it can be seen that the mounting block is designated generally by the numeral 30. The mounting block 30 has a set of three through holes 116 extending therethrough. Concentrically aligned with each hole 116 is a support rod counterbore 112 on one side and a fastener counterbore 116 on an opposite side. Accordingly, fasteners 118 are received in the fastener holes 116 for the purpose of securing the support rod 26 and the center rod 48 to the mounting block 30. Also extending through the mounting block 30 are a pair of fixture mount holes 120 which may receive rubber pads for absorbing vibrations and the like when the fixture is mounted inside a housing.

Advantages of the fixture 20 are readily apparent. In particular, the use of two different materials to support the flow cell block allows for the flow cell block to be held in a constant position with respect to the camera block. The imaging system can work in an acceptable manner with the fixture 20 as long as the optical flow cell remains within a field of view of at least 150 microns from a set position from the camera block. In other words, the overall system is able to adequately image debris particles as long as movement of the flow cell block with respect to the camera block keeps the flow cell in an area limited to 150 microns. Preferably, the movement of the flow cell block is no more than 50 microns in either direction to accommodate the cross-section width of the optical flow cell which is about 100 microns. In any event, with the materials selected, it is believed that the position of the flow cell block and thus the position of the flow cell changes only about 1 micron with a change in temperature of about 17° F. Since the inner center rod expands a greater amount than the outer support rods and since the support rods are longer, the change in the field of view is negligible for the construction disclosed herein. The assembly is also advantageous in that an optical flow cell may be easily replaced by detaching the flow cell door from the flow cell block, removing and then reattaching a new flow cell and then closing the door again. Although it is believed that the fixture will be contained in a laboratory environment with well regulated temperatures, it is believed that with proper material selection of support rod and center rod materials, the fixture may be used in a harsher environment.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. An optical debris analysis fixture for obtaining a precise focus point for imaging debris passing through an optical flow cell, comprising:
a support assembly having opposed first and second fixed ends;
a flow cell block slidably carried by said support rod assembly; and
a fixed rod secured at one end to said second fixed end and at an opposite end to said flow cell block

2. The fixture according to claim 1, wherein said support assembly and said fixed rod are made of dissimilar materials such that a change in temperature results in negligible positional change between said flow cell block and said first fixed end.

3. The fixture according to claim 1, further comprising:
a camera mounting block extending from said first fixed end;
a lens support block carried by said support assembly; and
a lens secured to said camera mounting block and supported by said lens support block.

4. The fixture according to claim 1, further comprising:
a flow cell door slidably carried by said support assembly and attachable to said flow cell block so as to form a flow cell cavity for receiving the optical flow cell.

5. The fixture according to claim 1, further comprising:
a fastener for connecting said flow cell block to said fixed rod, wherein said flow cell block is precisely positioned with respect to said first end of said support assembly when said fastener is secured.

6. The fixture according to claim 5, wherein said support assembly comprises a pair of spaced apart parallel rods of substantially equal length, wherein said rods are made of stainless steel.

7. The fixture according to claim 6, wherein said fixed rod is positioned between said parallel rods, and said flow cell block is positioned between said first and second ends of said support assembly, and wherein said fixed rod is made of aluminum.

8. The fixture according to claim 7, wherein a ratio of the coefficients of thermal expansion of said fixed rod and said parallel rods is substantially equal to the inverse of their respective lengths.

9. A fixture for imaging particles passing through an optical flow cell, comprising:
a camera block;
a mounting block;
a pair of parallel spaced apart rods of substantially equal length having first and second ends, wherein said first ends are secured to said camera block and said second ends are secured to said mounting block;
an optical flow cell block for carrying the optical flow cell, said optical flow cell block slidably carried by said pair of rods between said camera block and said mounting block; and
a fixed rod extending from said mounting block, said optical flow cell block secured to one end of said fixed rod so that said optical flow cell block moves no more than 50 microns from a set position from said camera block even with a predetermined change in the ambient temperature.

10. The fixture according to claim 9, wherein as the temperature increases, said fixed rod thermally expands at a rate greater than said pair of rods.

11. The fixture according to claim 10, wherein said fixed rod is made of aluminum.

12. The fixture according to claim 10, wherein said pair of rods are made of stainless steel.

13. The fixture according to claim 10, wherein said mounting block and said camera block have holes therethrough for receiving shock pads.

14. The fixture according to claim 9, wherein a ratio of the coefficients of thermal expansion of said fixed rod and said parallel rods is substantially equal to the inverse of their respective lengths.
